(19) United States
(12) Patent Application Publication
(10) Pub. No.: US 2008/0215767 A1
(43) Pub. Date: Sep. 4, 2008

(54) Storage usage exclusive method

(75) Inventors: Akihisa Nagami, Yokohama (JP); Shinji Kimura, Sagamihara (JP); Mitsuru Ikezawa, Sagamihara (JP); Ikuko Kobayashi, Kawasaki (JP); Daisuke Yokota, Kawasaki (JP); Hiroji Shibuya, Odawara (JP); Yukinobu Mizoguchi, Odawara (JP)

Correspondence Address: Stanley O. Fisher;Reed Smith LLP, 3110 Fairview Park Drive, Suite 1400, Falls Church, VA, 22042-4503, US

(73) Assignee: Hitachi, Ltd.

(21) Appl. No.: 12/010,498

(22) Filed: Jan. 25, 2008

(30) Foreign Application Priority Data
Mar. 2, 2007 (JP) 2007-052172

(51) Int. Cl. G06F 3/00

(52) U.S. Cl. 710/19

(57) ABSTRACT

In an environment where there is a possibility that the user connects from a plurality of blade PCs to the storage, the present invention prevents the data destruction by realizing the exclusive control of the storage device. The storage connection from a blade PC which was possible to connect until now is made to be impossible by that the management server newly generates and sets to the storage device the connection information between the storage device which the blade PC keeps. Further, by sending the newly generated connection information to the other blade PC the connection from that blade PC becomes possible.

### INCORPORATION BY REFERENCE

The present application claims priority from Japanese application JP2007-052172 filed on Mar. 2, 2007, the content of which is hereby incorporated by reference into this application.

### BACKGROUND OF THE INVENTION

The present invention relates to a thin client, a blade PC, a management server, and a storage device, and more specifically it relates to an exclusive method of usage from the blade PC to the storage device.

Recently, as the notebook PC has become popular it has become possible to work outside the company. On the other hand, the information leakage by losing the notebook PC, etc. is becoming a social problem. In order to solve such a problem, a thin client system which uses a user terminal (hereinafter it will be called a thin client) and a highly integrated computer (hereinafter it will be called a blade PC) has started to be introduced as a system with which a user can continue to work even outside the company limiting taking out of the company information.

Also, in the above-mentioned information processing system the storage mounted on the blade PC was a hard disk of 2.5 inch type, etc., but an information processing system which is provided for the blade PC of the individual substituting a storage device which is a more highly reliable storage for this hard disk has been developed. This more highly reliable storage device may be FC-SAN or NAS, moreover it may be iSCSI with which an inexpensive system can be built without additional hardware. In all cases, by providing a storage of RAID configuration for the blade PC, it has been tried to be able to use it as a highly reliable disk area or a backup area.

By the way, in this information processing system, when a blade PC which has been assigned to a certain user (hereinafter it will be called a main assignment blade PC) failed, it is necessary to provide another blade PC (hereinafter it will be called an alternative assignment blade PC) according to a request from the user.

However, as to this switching to the alternative assignment blade PC, a problem such as below occurs.

First, when the storage device is a disk of FC or iSCSI, in many cases that storage device is formatted with NTFS or FAT, etc. and if it is used from the alternative assignment blade PC with the main assignment blade PC mounted under such a file system, there is a possibility that a file would be lost or a file system would be destroyed.

As a system in which a certain disk area is shared by a plurality of hosts there is a cluster system as a patent document 1 mentioned below. In such a cluster system, when a plurality of hosts access a certain disk area the double mount from the both hosts is avoided performing the exclusion of the disk using reserve, release, reset which are the SCSI commands and controlling the access right between a main server and a sub server which configure the cluster. Namely, because with such an exclusive control by the SCSI commands it is necessary that the host which uses that storage performs it by itself, it is necessary to monitor each other's access, but in the above-mentioned main-sub configuration of the server, as the network addresses of each other are known, it was possible to control the priority by monitoring each other.

### SUMMARY OF THE INVENTION

On the other hand, when the alternative blade PC is assigned in the above-mentioned information processing system, for example, as it is dynamically assigned according to the request from the user when a problem has occurred to the main assignment blade PC, there was a problem that the main assignment blade PC could not know the address of the alternative assignment blade PC and it was difficult to monitor the access each other.

Therefore, the present invention provides a technique which realizes the exclusion of the usage of the storage device of the main assignment blade PC and the alternative assignment blade PC in order to solve above-mentioned problem.

An information processing system of the present invention which is to solve the above-mentioned problem is an information processing system comprising a blade PC, a thin client, a management server, and a storage device which are connected to each other via a network, wherein said thin client comprises an address obtaining part which reads storage information of a portable type storage medium which a user of said thin client uses, obtains an address of the blade PC which is to be an usage assignment destination of said thin client, stores data of this address in a memory, when the address is not stored in the portable type storage medium makes an address obtaining request to the management server, further requests assignment of an alternative blade PC according to an operation of the user, a connection establishment part which sends a connection establishment request including at least information for authentication of said thin client or the user to the address of information processing device stored in the memory, and according to response data which the information processing device returns in response to this connection establishment request performs a connection establishment process between the information processing device and said thin client via the network, and a remote operation part which in accordance with the performance of the connection establishment process sends operation information input at an input interface of said terminal to the address of the information processing device, receives image information corresponding to said operation information from the information processing device, and displays it on an output interface of said terminal, the blade PC comprises a connection management table which stores information for authentication of the thin client which is usage assigned to said blade PC or the user, an authentication part which receives the connection establishment request sent from the thin client, checks the information for authentication of the thin client or the user which this connection establishment request includes with the connection management table, decides whether to accept the connection establishment request, and returns its decision result to the thin client as response data, a remote operation acceptance part which receives operation information from the thin client with the performance of a connection establishment process between the terminal according to the authentication result, performs information processing according to operation contents which said operation information indicates, and sends image information which shows its result to said terminal, a storage connection information table which stores the authentication information necessary to the connection between the storage device which includes at least the authentication information of the user or the blade PC and a destination address of storage, a storage connection information receiving part which stores storage connection information sent from the management server to the storage connection information table, a storage connection part which reads out information stored in the storage connection information table, connects to an address of the storage device recorded there, establishes the connection sending the authentication information, and processes read/write from and to the storage device thereafter, and a power operation acceptance part which changes power condition of said blade PC in accordance with a power control request from the management server, the management server comprises a blade PC assignment management table which includes at least user identification information and main assignment blade PC identification information and according to circumstances stores alternative assignment blade PC information, a storage assignment management table which includes at least the user identification information and storage information, a blade PC assignment part which receives an assignment request of blade PC from the thin client, refers to the blade assignment management table, and performs the assignment of a main assignment blade PC and an alternative assignment blade PC, a blade PC power control part which turns on power to the blade PC which is assigned to the user and sends a request to turn off power to the blade PC which is released from the assignment to the power operation acceptance part of the blade PC, a storage connection information generating part which on the assignment of the alternative blade PC according to the request from the user newly generates the storage connection information and stores it in the storage assignment management table, a storage setting part which refers to the storage assignment management table and changes the connection information for the storage device which is assigned to the user, and a storage information sending part which refers to the blade PC assignment management table, refers to the storage assignment management table for the blade PC which is assigned to the user, and sends the connection information of the storage device which is assigned to the user, the storage device comprises a storage management table which associates a memory part which is assigned to the user, the storage connection information, and the user identification information, a storage setting management part which accepts change of the storage connection information from the management server and rewrite the storage management table, a storage connection part which refers to the storage management table for a storage connection request from the blade PC, decides the connection, establishes the connection, and for read/write requests of data receives and sends its information from and to a memory part, and a memory part which stores data passed from a write request from the user and refers for a read request.

Other than the above, the object which the present invention discloses and its solution will be made apparent by the section of the embodiment of the invention and the drawings.

According to the present invention, the exclusion of the storage usage between the main assignment blade PC and the alternative assignment blade PC can be realized.

### BRIEF DESCRIPTION OF THE DRAWINGS

FIG. 1 is a thin client system of the present embodiment.

FIG. 2 is a physical configuration of an information processing device according to the present embodiment.

FIG. 3 is a blade management table in a management server of the present embodiment.

FIG. 4 is a storage assignment management table in the management server of the present embodiment.

FIG. 5 is a connection management table in a blade PC of the present embodiment.

FIG. 6 is a storage connection information table in the blade PC of the present embodiment.

FIG. 7 is a storage management table in a storage device of the present embodiment.

FIG. 8 is an address storage table in a portable type storage device of the present embodiment.

FIG. 9 is a normal connection process flow (No. 1) of the blade PC in the present embodiment.

FIG. 10 is a normal connection process flow (No. 2) of the blade PC in the present embodiment.

FIG. 11 is a flow of alternative device assignment process (No. 1) in the present embodiment.

FIG. 12 is a flow of alternative device assignment process (No. 2) in the present embodiment.

FIG. 13 is a flow of maintenance process of a main assignment blade PC in the present embodiment.

FIG. 14 is a flow of alternative device assignment return process (No. 1) in the present embodiment.

FIG. 15 is a flow of alternative device assignment return process (No. 2) in the present embodiment.

FIG. 16 is a flow of disk maintenance process (No. 1) in the present embodiment.

FIG. 17 is a flow of disk maintenance process (No. 2) in the present embodiment.

### DESCRIPTION OF THE EMBODIMENT

An embodiment of the present invention will be explained below using the drawings. Now, in this embodiment a blade PC with entity will be explained as an example, but the present invention is applicable to a PC which operates in a virtual machine.

### —System Configuration—

It will be explained in detail below about the embodiment of the present invention using the drawings.

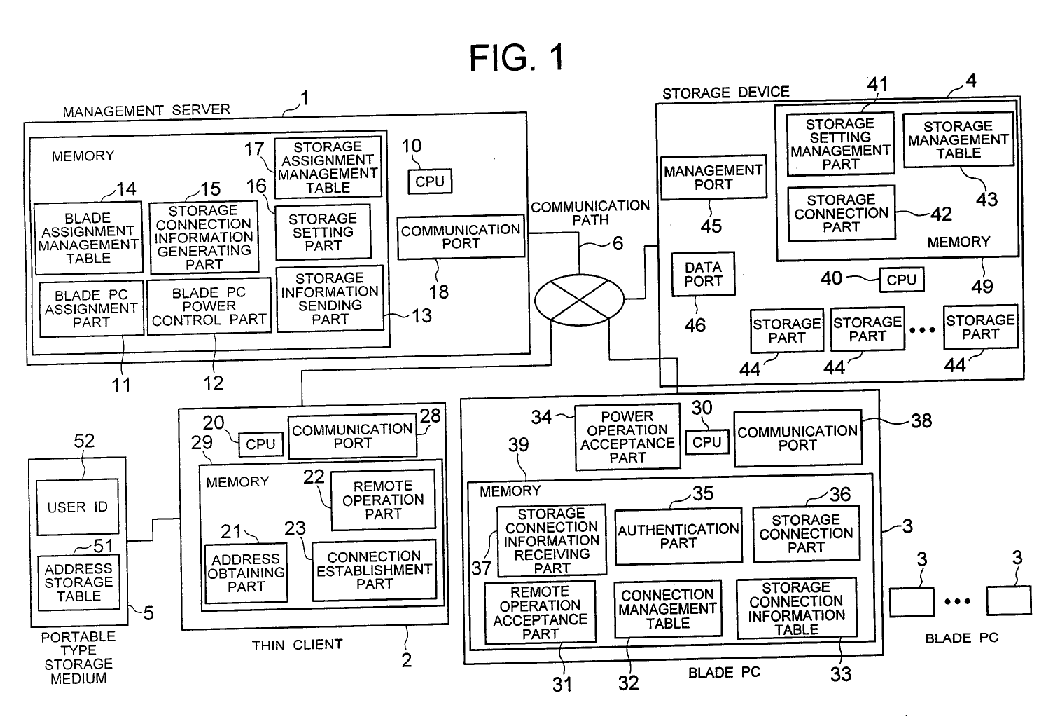

FIG. 1 is a network configuration diagram of a thin client system which is an information processing system of this embodiment. The thin client system shown in FIG. 1 is a system which comprises a management server (1), one or more thin client (2), one or more blade PC (3), and a storage device (4) which are connected to each other via a communication path (6), and the thin client (2) is a system which comprises a portable type storage medium (5).

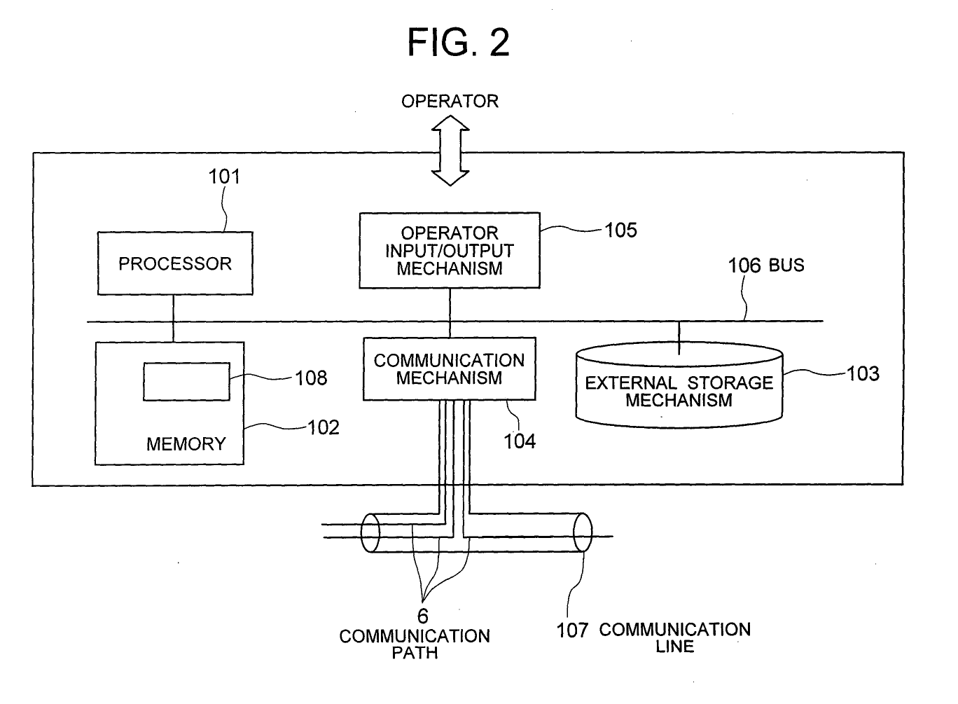

FIG. 2 shows an example of physical configuration of each device of the management server (1), the thin client (2), the blade PC (3), and the storage device (4) according to this embodiment. These devices physically may be typical information processing devices as shown in FIG. 2. More specifically, each device is configured, for example, in the form in which a processor (101), a memory (102), an external storage mechanism (103), a communication mechanism (104), and an operator input/output mechanism (105) are connected by an internal communication line (106) such as a bus.

The processor (101) executes an information processing program (108) stored in the memory (102).

The memory (102) keeps each kind of data which is referred to from the information processing program (108) other than the information processing program (108).

The external storage mechanism (103) keeps the information processing program (108) and each kind of data in the non-volatile form.

The information processing program (108) is executed by the above-mentioned processor (101), instructs the external storage mechanism to load necessary program and data to the memory (102) and store the information processing program (108) and data on the memory (102) to the external storage mechanism (103). Here, the information processing program (108) may be previously stored in the external storage mechanism (103). Or, as the need arises, it may be installed from an external device via a portable type storage medium or a communication medium.

The communication mechanism (104) is connected to a communication line (107) and sends data to other information processing device or communication device according to the instruction of the information processing program (108) or conversely receives data from other information processing device or communication device and stores it in the memory (102).

A logical communication path (6) between the devices is via this communication mechanism (104) and is implemented through the physical communication line (107).

The operator input/output mechanism (105) inputs and outputs data from and to the operator.

The internal communication line (106) is for that the processor (101), the memory (102), the external storage mechanism (103), the communication mechanism (104), and the operator input/output mechanism (105) communicate each other, and, for example, is configured with a bus.

The management server (1), the thin client (2), the blade PC (3), and the storage device (4) do not necessarily need to have physically different configuration and the difference of the functions of each device is implemented by the information processing programs (108) which run on each device.

Also, each function part such as a storage connection information generating part, etc. which is used on explaining the components in this embodiment may be logically configured by software, may be configured in hardware by dedicated LSI, etc., further, it may be implemented by a combination of software and hardware. Now, when it is logically configured each function part has it function implemented by being stored on the memory and executed by the processor.

Also, the management server (1), the thin client (2), the blade PC (3), and the storage device (4) do not need to be independent physical devices respectively and one device may implement at the same time functions of a plurality of devices of the management server (1), the thin client (2), the blade PC (3), and the storage device (4). Moreover, each processing part of each device does not need to be configured by one device and it may be implemented by different devices.

Below, it will be explained about the function parts which each of the management server (1), the thin client (2), the blade PC (3), and the storage device (4) comprises.

The management server (1) in FIG. 1 is provided with a blade PC assignment part (11), a blade PC power control part (12), a storage information sending part (13), a blade assignment management table (14), a storage connection information generating part (15), a storage setting part (16), and a storage assignment management table (17), and according to an assignment request of the blade PC (3) from the thin client (2), refers to the blade assignment management table (14) and assigns the blade PC (3) to the thin client, and refers to the storage assignment management table (17) and sends storage connection information to the blade PC (3).

The thin client (2) is provided with an address obtaining part (21), a remote operation part (22), and a connection establishment part (23), and can be connected to the portable type storage medium (5). The portable type storage medium (5) is provided with an address storage table (51) and a user ID (52) in which ID information which is unique to the user is stored, and the address obtaining part (21) of the thin client (2) can read and write information from and to the address storage table (51) and can read the user ID (52). Thereby, it is possible to store destination information of the blade PC (3) in the portable type storage medium (5) and to move it, and to make an assignment request of a new blade PC (3) to the management server (1) and to move information of the new blade PC using the portable type storage medium.

The blade PC (3) is provided with a remote operation acceptance part (31), a connection management table (32), a storage connection information table (33), a power operation acceptance part (34), an authentication part (35), a storage connection part (36), and a storage connection information receiving part (37), and accepts a connection request from the thin client, and the operation of said blade PC (3) can be operated from the thin client. In said thin client system, said blade PC (3) can be configured by a plurality of blade PCs of two or more. When said blade PC (3) failed and it becomes impossible to operate it from the thin client (2), by that the management server (1) assigns an alternative blade PC (3), the thin client (2) becomes able to remotely operate the alternative assignment blade PC (3).

The storage device (4) is provided with a storage setting management part (41), a storage connection part (42), a storage management table (43), and one or more storage part (44). By including a plurality of storage parts (44) of two or more, it is possible to provide the storage part (44) to a plurality of users. The storage part (44) is assigned per user, and its connection information is managed at the storage management table (43).

### —Database Structure—

Next, it will be explained about the database structure which each of the management server (1), the thin client (2), the blade PC (3), and the storage device (4) has in this embodiment.

The management server (1) is provided with the blade assignment management table (14) and the storage assignment management table (17) as database.

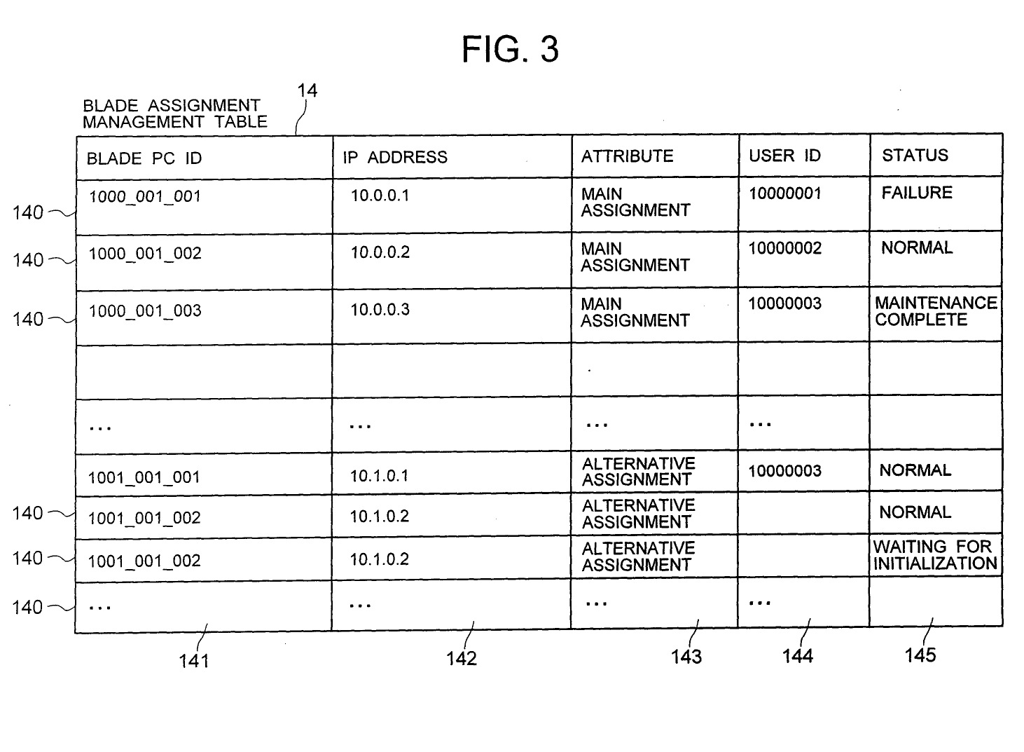

The blade assignment management table (14) shown in FIG. 3 is provided with a blade PC ID (141) and an IP address (142) which is a network address of that blade PC, an attribute (143) which indicates the from of the assignment, when a blade PC is assigned a user ID (144) which indicates to which user the blade PC is assigned, and a status (145) which indicates the assignment condition of that blade PC. In the case of said blade assignment management table (14), one blade PC is managed with its one line (140). The blade PC ID (141) does not duplicate with other lines and preferably the ID is the one with which the line is specified uniquely. The IP address (142) which specifies the location of the blade PC on the network is supposed to be an IP address in this embodiment, but it may be an address which is defined uniquely on the network. The attribute (143) is supposed to include the forms of assignment such as a main assignment, an alternative assignment, etc. in this embodiment, but depending on the circumstances an assignment form such as a dynamic assignment may be included.

Here, the main assignment means an assignment form for the user to use it mainly and continually, the alternative assignment means a temporary assignment form when the blade PC of the main assignment cannot be used because of a fault, etc. Also, the dynamic assignment means an assignment method of a form in which the relation between the user and the blade PC is supposed to be a temporary relation while the user uses it and after a certain user finishes using a certain blade PC, that blade PC is to be assigned to another user. The status (145) is supposed to include normal, failure, maintenance complete, waiting for initialization, etc. in this embodiment, but it may include statuses other than these.

Here, the normal of the status means a status in which the blade PC has no fault, etc. and the user can use it normally, or a status in which the blade PC of alternative assignment is not assigned to anyone. The failure is a status of the blade PC of main assignment when a fault has occurred to the blade PC of main assignment and the blade PC of alternative assignment is assigned to the user. When the maintenance of that blade PC has been completed, the status becomes the maintenance complete status, and it means that it is the status in which the user can use the blade PC of his or her main assignment again. When the main assignment blade PC is returned to the user, the blade PC of alternative assignment which has been used until then enters the status of waiting for initialization, and it means the status in which the initialization by the administrator is necessary. When the initialization is completed it becomes the normal status and enters the status in which the alternative assignment is possible again.

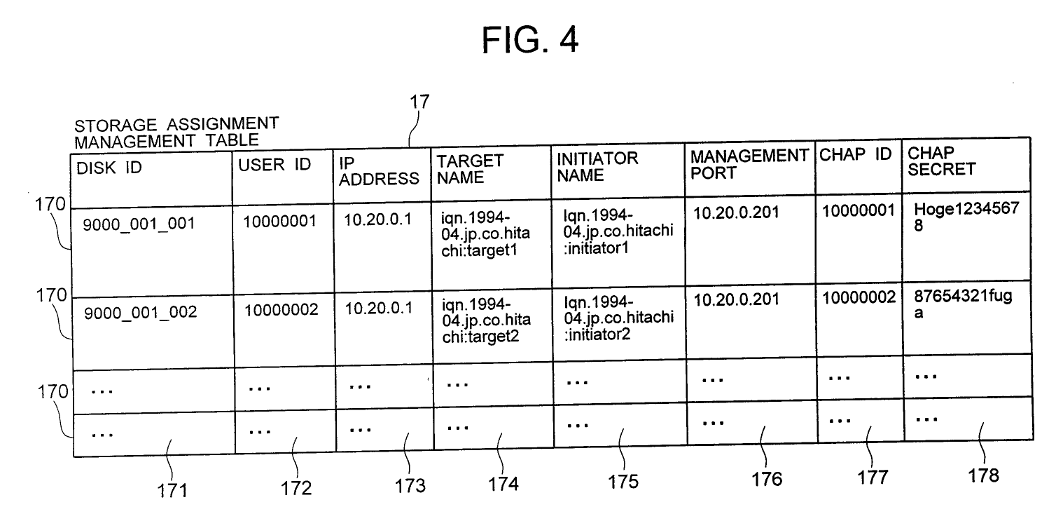

The storage assignment management table (17) shown in FIG. 4 is provided with a disk ID (171) with which the storage part (44) can be specified uniquely, when that disk is assigned to the user a user ID (172) which stores its user ID, and connection destination information. As this connection destination information, here the connection protocol is assumed to be iSCSI and the following information is supposed to be the connection destination information: an IP address (173) which indicates the connection destination of the assigned storage, a target name (174), an initiator name (175), a management port (176), a CHAP ID (177), and a CHAP Secret (178). Now, the connection protocol is not limited to the iSCSI protocol, and it may be a connection by Fibre Channel or NAS. In this case, it is supposed to keep the connection information according to that protocol. If it is NAS, it is supposed to have an IP address of NAS, a name of mount point, and authentication information, and if it is Fibre Channel, it is supposed to have a WWN (World Wide Name).

The blade PC (3) is provided with the connection management table (32) and the storage connection information table (33) as database.

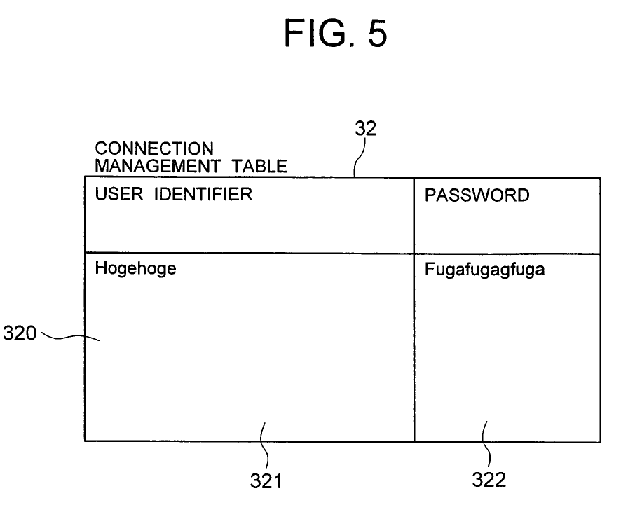

An example of the connection management table (32) is shown in FIG. 5. The connection management table (32) is a table for the case where the authentication part (35) accepts the connection request sent from the connection establishment part (23) of the thin client (2) it refers to the connection management table and performs the authentication and decides whether or not to establish the connection. In this embodiment, said connection management table is supposed to be provided with a user identifier (321) with which the user who have accessed said blade PC is specified, and a password (322) based on a model of user password authentication. This may be a model of client authentication by the exchange of certificate information.

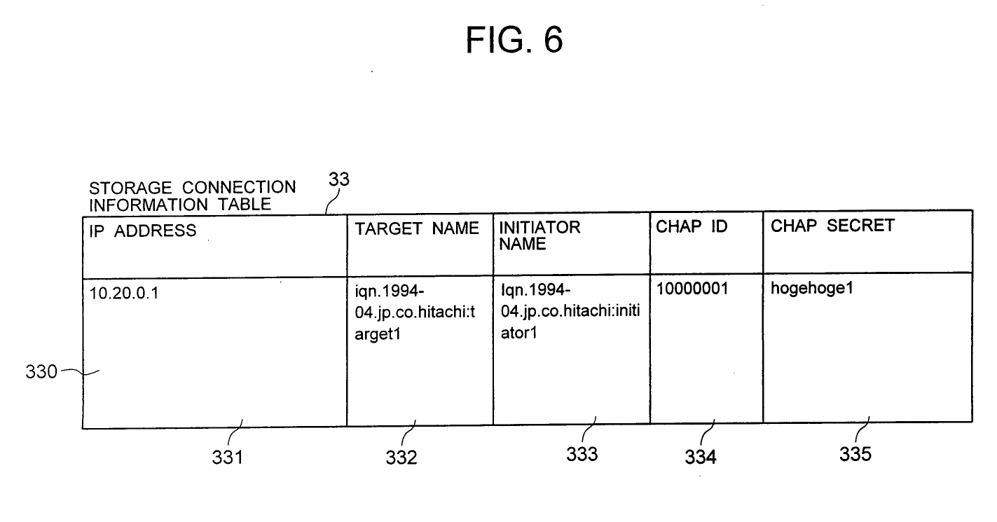

An example of the storage connection information table (33).is shown in FIG. 6. In the storage connection information table (33), connection information to connect said blade PC to the storage device (4) and to use the storage part (44) assigned to the user is stored. In the same way as the storage assignment management table (17), as in this embodiment it is supposed the iSCSI connection the connection information is the storage connection information which is necessary to the iSCSI connection, but in the same way as the storage assignment management table (17), it may be a Fibre Channel connection or a NAS connection. In this embodiment, it is provided with an IP address (331) which means a connection destination address of the storage device, a target name (332), an initiator name (333), a CHAP ID (334), and a CHAP Secret (335). This information is generated by that the storage information sending part (13) of the management server (1) refers to the storage assignment management table (17), sends to the storage connection information receiving part (37) of the blade PC (3) assigned to the corresponding user, and the storage connection information receiving part (37) which received it writes said received storage connection information to the storage connection information table (33). A line (330) of the storage connection information table (33) means that there is not an assignment of the storage when there is not a line, and means that there are storages which have been assigned when there are one or more lines and they can be connected to respectively.

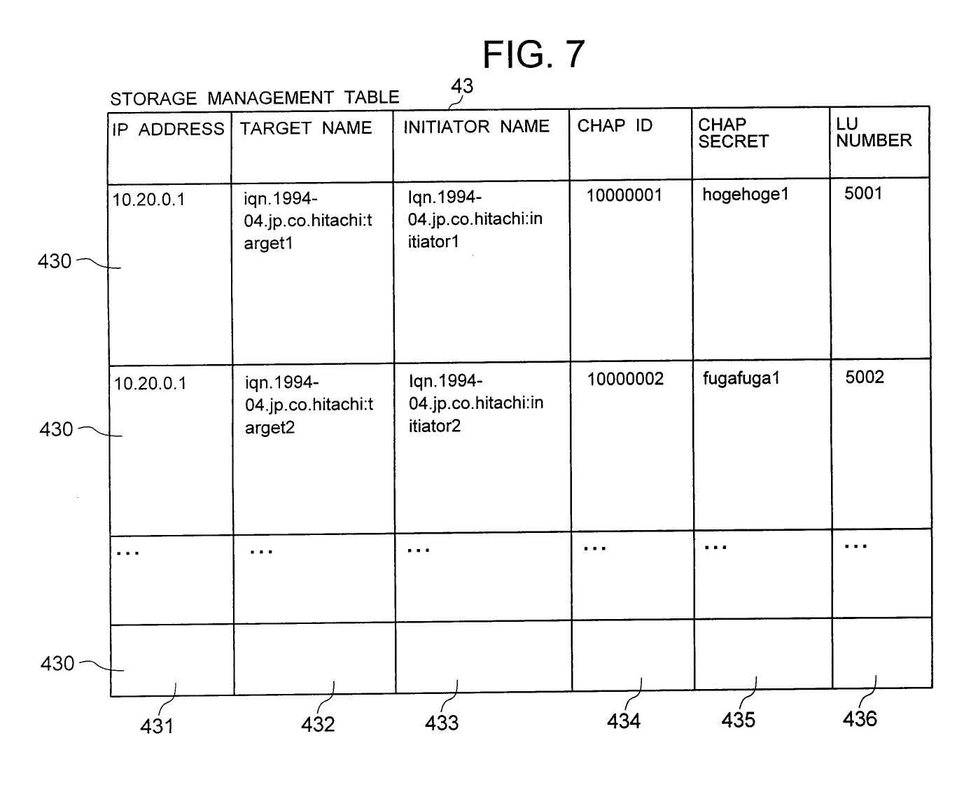

The storage device (4) is provided with the storage management table (43) shown in FIG. 7 as database. In this embodiment, as the storage connection information table is configured taking as an example a storage device which is capable of the iSCSI connection, it is provided with an IP address (431) of the storage device which is address information waiting for the connection to the storage device (4), a target name (432), an initiator name (433), a CHAP ID (434), a CHAP Secret (435), and a LU number (436) which indicates the storage part. Each information of said storage management table (43) is information which the storage setting part (16) of the management server (1) refers to the storage assignment management table (17), sends the storage connection information to the storage setting management part (41) of the storage device (4), and the storage setting management part (41) writes the received storage connection information to the storage management table (43). Further, when the storage connection part (36) of the blade PC (3) connects to the storage connection part (42) of the storage device (4), the storage connection information stored in the storage connection information table (33) which the storage connection part (36) sends and the information in the storage management table (43) are compared and it is decided whether to connect or not.

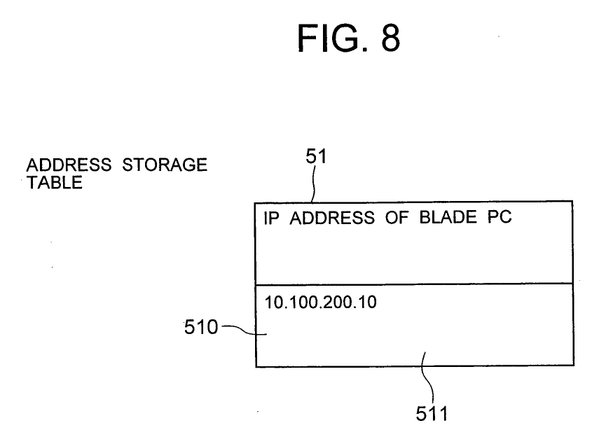

The portable type storage medium (5) is provided with an address storage table (51) shown in FIG. 8. Here, as the thin client (2) is assumed to use IP as a connection method between the blade PC (3), the IP address is supposed to be stored in the address storage table (51). However, another identifier may be used as long as it is an identifier with which the blade PC of connection destination can be specified uniquely on the network.

### —Example of Process Flow—

Below, it will be explained about the actual procedure of the information processing method in this embodiment based on the drawings. Now, each kind of operations corresponding to the information processing method which will be explained below is implemented by that the processor executes the programs read out on a RAM of each of the management server (1), the thin client (2), the blade PC (3), and the storage device (4) which configure the information processing system. And, this program is configured with the codes to perform each kind of operations which will be explained below.

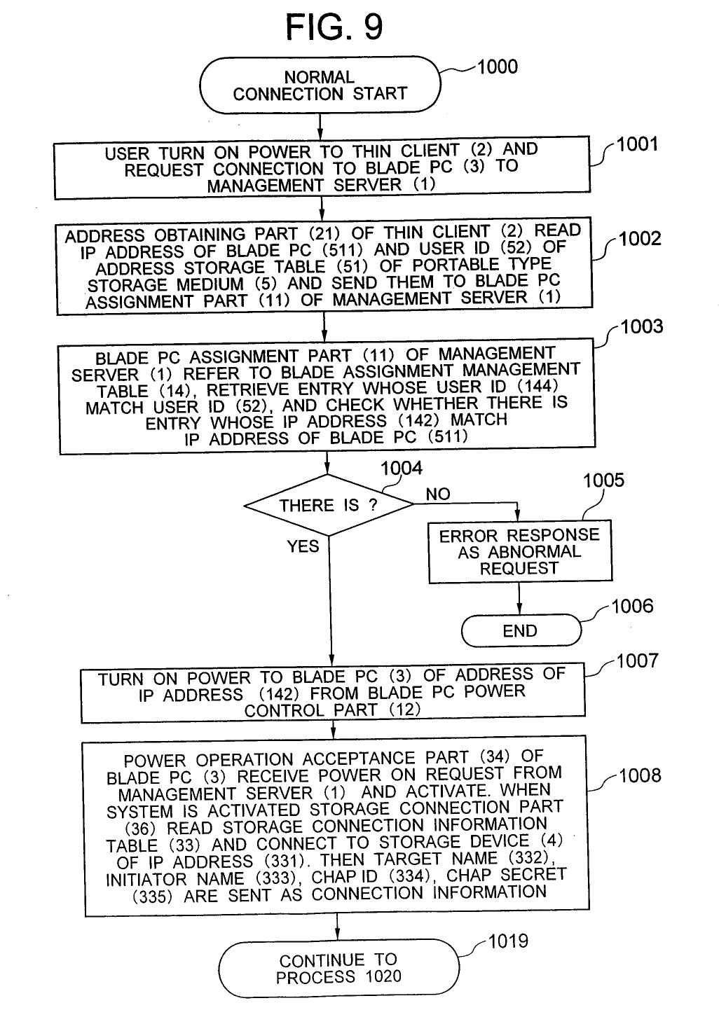

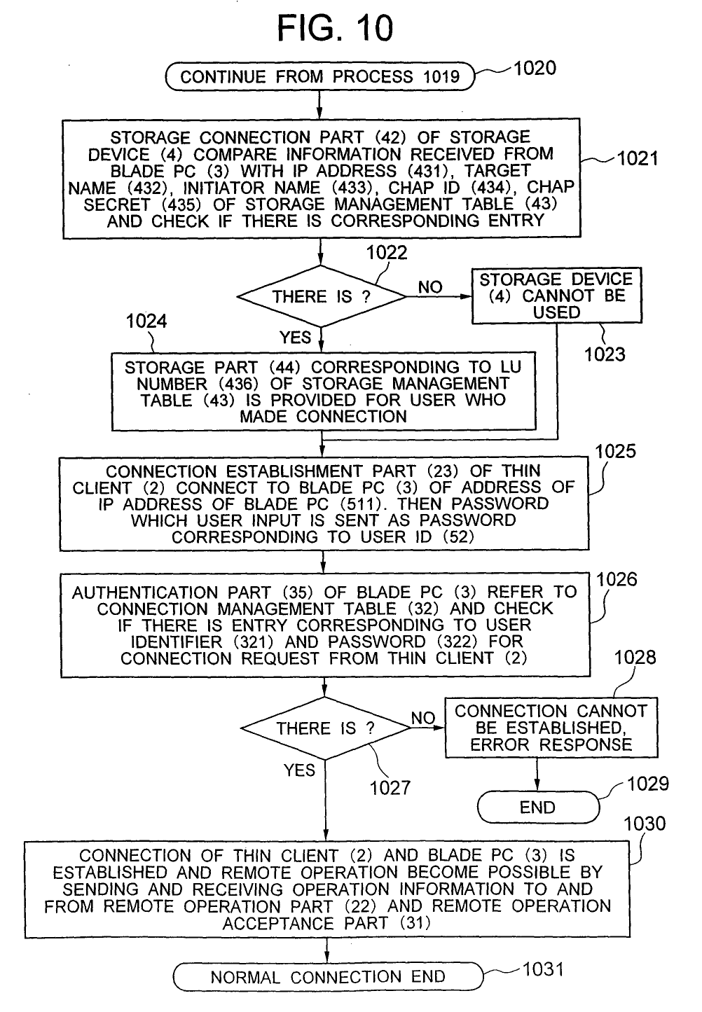

In FIGS. 9 and 10, an example of the process flow until the blade PC (3) connects to the storage device (4) and the blade PC (3) becomes possible to be used from the thin client (2) is shown.

First, a normal connection process is started assuming that the user of this system tries to use the blade PC (3) using the thin client (2).

The user turns on power to the thin client (2) and makes a request to connect to the blade PC (3) from the thin client (2) to the management server (1) (process 1001). The address obtaining part (21) of the thin client (2) reads in an IP address of blade PC (511) and a user ID (52) of the address storage table (51) of the portable type storage medium (5) and sends them to the blade PC assignment part (11) of the management server (1) (process 1002). The blade PC assignment part (11) of the management server (1) refers to the blade assignment management table (14), retrieves whether there are entries whose user IDs (144) match the received user ID (52), and checks if there is an entry among these entries (140) whose IP address (142) matches the IP address of blade PC (511) (process 1003).

If there is not an entry at the branch of process 1004, the system returns an error response as an abnormal request (process 1005). Then the normal connection process is terminated (process 1006).

If there is an entry at the branch of the process 1004, a request to turn on power is made from the blade PC power control part (12) to the blade PC (3) of the address of the IP address (142). Here, if the power has already been turned on, there is no need to turn on power. Also in this example, the power is turned on via the management server, but a method to perform the power control from the thin client (2) by preparing an appropriate authentication means may be used. The power operation acceptance part (34) of the blade PC (3) receives the power on request from the management server (1) and activates the OS based on said power on request. When the system has been activated, the storage connection part (36) of the blade PC reads in the storage connection information table (33) and makes the connection to the storage device (4) specified by the IP address (331). On this occasion, the target name (332), the initiator name (333), the CHAP ID (334), and the CHAP Secret (335) are sent to the storage device (4) as connection information (process 1008). Here, the above-mentioned information is sent as the connection information assuming the iSCSI connection, but it may be considered in the same way as information such as a connection user ID, a password, and WWN, etc. which are necessary for the connection in a NAS device, a FC device, and a variety of storage devices.

The storage device (4) confirms the received connection information. The storage connection part (42) of the storage device compares the above-mentioned connection information received from the blade PC (3) with the IP address (431), the target name (432), the initiator name (433), the CHAP ID (434), and the CHAP Secret (435) of the storage management table (43) and confirms whether there is a corresponding entry (430) (process 1021).

If there is not an entry at the decision of process 1022, the storage device (4) cannot be used (process 1023) and an error is sent as an abnormal request.

If there is an entry at the decision of the process 1022, the storage part (44) which corresponds to the LU number (436) of the corresponding entry (430) of the storage management table (43) is provided for the user of the access origin (process 1024). The connection establishment part (23) of the thin client (2) makes the connection to the blade PC (3) of the IP address (511) which specifies a certain blade PC. Thereafter, the user inputs a password corresponding to the user ID (52) in order to perform the authentication of the thin client (2) and the blade PC (3) (process 1025). Now, the method of connection authentication of the thin client (2) and the blade PC (3) uses the user ID and the password in this embodiment, but a method using the biometric authentication information or the PKI method using the certification may be used.

The authentication part (35) of the blade PC (3) refers to the connection management table (32) and confirms whether there is an entry (320) corresponding to the user identifier (321) and the password (322) according to the connection request from the thin client (2) (process 1026).

If there is not an entry at the process 1027, the connection cannot be established and the system returns an error response (process 1028). Then the connection process is terminated (process 1029).

If there is an entry at the process 1027, the connection between the thin client (2) and the blade PC (3) is established and the remote operation becomes possible by that the operation information is communicated between the remote operation part (22) of the thin client and the remote operation acceptance part (31) of the blade PC and that the session is established (process 1030). Here, the operation information is terminal information basically necessary for the operation of the PC which includes both information obtained from the input device such as a keyboard or a mouse and screen information of the process result.

The usage of the blade PC (3) connected to the storage device (4) has become possible from the thin client (2) by the above processes (process 1031).

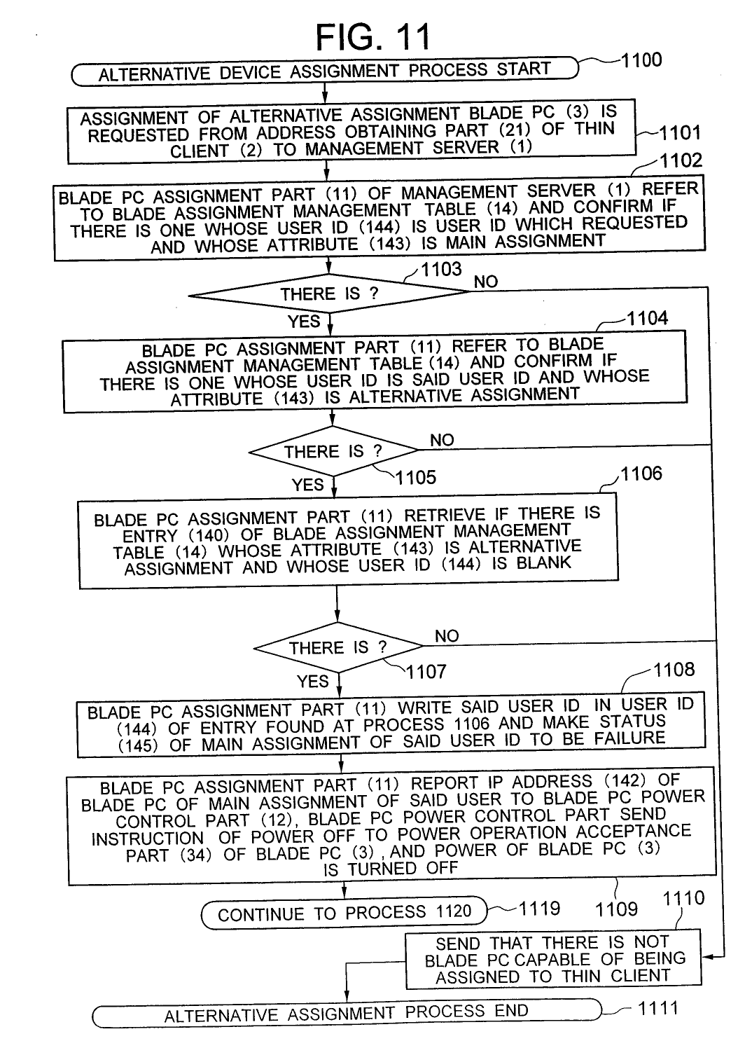

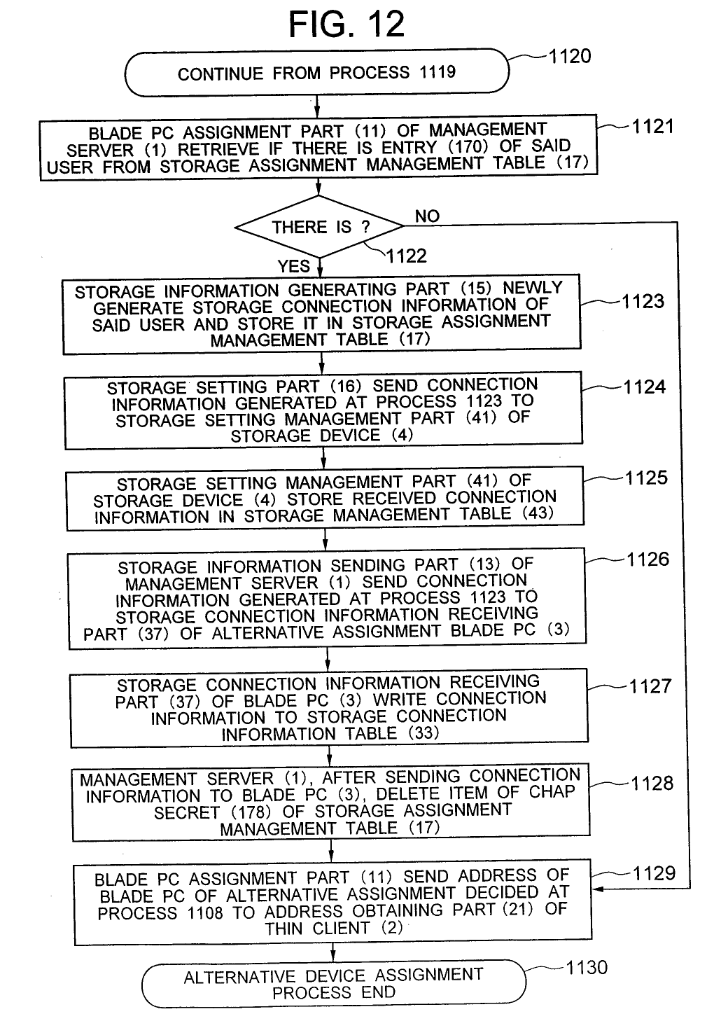

In FIGS. 11 and 12, an example of the process flow when the alternative assignment of the blade PC (3) is performed is shown. As an example of this case where the alternative blade PC is assigned it can be considered the case where a fault has occurred to the main assignment blade PC and the power control using mBMC cannot be done well and the power cannot be turned off, or the case where the main assignment blade PC is infected with virus or malware and it cannot be controlled. In these cases, it is necessary to cut off the access from the main assignment blade PC to the storage device and to perform the alternative assignment in which the storage device is made to be able to be used only from the alternative assignment blade PC. It will be explained about its process flow below.

First, the user requests a blade PC of alternative device assignment of the blade PC of main assignment operating the thin client terminal (process 1100). The assignment of the alternative device assignment blade PC (3) is requested from the address obtaining part (21) of the thin client (2) to the management server (1) (process 1101). The blade PC assignment part (11) of the management server (1) refers to the blade assignment management table (14) and confirms whether there is a user ID whose user ID (144) corresponds to the user ID sent and whose attribute (143) is the main assignment (process 1102).

If there is not a corresponding entry (140) at the branch of process 1103, it is sent to the thin client that there is not a blade PC capable of being assigned (process 1110). Then the alternative device assignment process is terminated as a failure (process 1111).

If there is an entry at the branch of the process 1103, the blade PC assignment part (11) refers to the blade assignment management table (14) and confirms whether there is an entry with said user ID and whose attribute (143) is the alternative assignment (process 1104).

If there is a corresponding entry (140) at the branch of process 1105, in this embodiment it is considered as a failure and it is sent to the thin client that there is not a blade PC capable of being assigned (process 1110). For example, as for the user ID “10000003” of FIG. 3, in this case as the alternative assignment has already been done to the user ID “10000003”, it is decided that more assignment cannot be done. Now, in this embodiment the above decision is made because the number of the blade PC which is to be alternatively assigned is supposed to be one, but in other embodiments the alternative assignment of a plurality of blade PCs may be performed without setting such a limit.

If there is not a corresponding entry (140) at the branch of the process 1105, in this embodiment the system proceeds to the next process and the blade PC assignment part (11) retrieves whether there is an entry (140) whose attribute (143) is the alternative assignment and whose user ID (144) is a blank in the blade assignment management table (140) (process 1106).

If there is not a corresponding entry (140) at the branch of process 1107, it is sent that there is not a blade PC capable of being assigned (process 1110), and the process is terminated (process 1111).

If there is a corresponding entry (140) at the branch of the process 1107, the blade PC assignment part (11) writes said user ID in the user ID (144) of the entry (140) which was found at the process 1006 and makes the status (145) of the main assignment of said user ID to be failure (process 1108). By changing the status (145) to failure it becomes easy for the administrator to retrieve the blade PC which needs the maintenance. The blade PC assignment part (11) of the management server reports the IP address (142) of the blade PC of main assignment of said user to the blade PC power control part (12), the blade PC power control part sends a instruction of power off to the power operation acceptance part (34) of the blade PC (3), and the power of the blade PC (3) is turned off (process 1109). The blade PC assignment part (11) of the management server (1) retrieves whether there is an entry (170) of said user from the storage assignment management table (17) (process 1121).

If there is not a corresponding entry (170) at the branch process of process 1122, the system will assign only the blade PC of alternative assignment, and the blade PC assignment part (11) sends the address of the blade PC of alternative assignment which was decided at the process 1108 to the address obtaining part (21) of the thin client (2) (process 1129) and the alternative device assignment process is terminated (process 1130).

If there is a corresponding entry (170) at the branch process of the process 1122, the storage information generating part (15) of the management server newly generates the storage connection information of said user and stores it in the storage assignment management table (17) (process 1123). Here, the connection information which the storage information generating part (15) generates may be any one of the IP address (173), the target name (174), the initiator name (175), the CHAP ID (177), and the CHAP Secret (178) of the storage assignment management table (17) as long as the authentication at the authentication mechanism does not match and the connection becomes failure. Here, the above authentication information has been listed assuming iSCSI as an example of the connection protocol between the storage device (4), but NAS or FC may be used as other connection protocols.

Below, it will be assumed that the CHAP Secret will be changed as an example of the case where the storage connection information is newly generated. The storage setting part (16) of the management server sends the new connection information generated at the process 1123 to the storage setting management part (41) of the storage device (4) (process 1124). The storage setting management part (41) of the storage device (4) stores the received new connection information in the storage management table (43) (process 1125). The storage information sending part (13) of the management server (1) sends the connection information generated at the process 1123 to the storage connection information receiving part (37) of the alternative assignment blade PC (3) (process 1126). The storage connection information receiving part (37) of the alternative assignment blade PC (3) writes the new connection information to the storage connection information table (33) (process 1127). The management server (1), after sending the connection information to the alternative assignment blade PC (3), deletes the item of the CHAP Secret (178) of the storage assignment management table (17) (process 1128). Here, the CHAP Secret (178) which is a password for the connection is deleted as an example, but other items may be deleted. Thereby, although the information of the management server is referred to abnormally, the entire connection information of the user will not be leaked. The blade PC assignment part (11) sends the address of the blade PC of alternative assignment which is decided at the process 1108 to the address obtaining part (21) of the thin client (2) (process 1129). Thereby, the alternative device assignment process is terminated (process 1130).

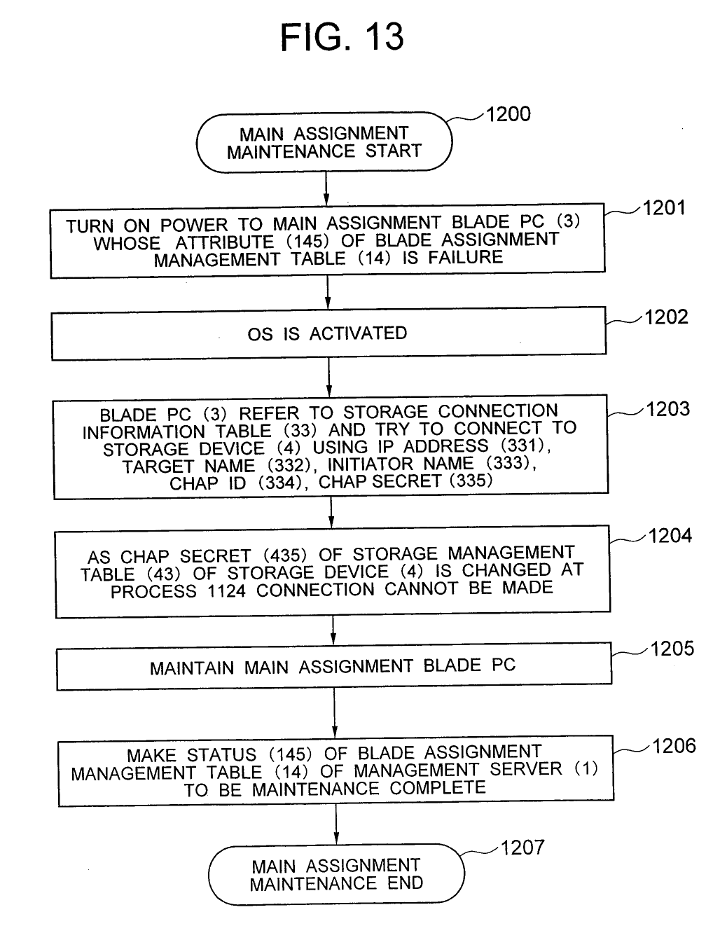

The process flow between the blade PC of main assignment and the storage device on the maintenance of said blade PC of main assignment will be shown below using FIG. 13. This is, for example, because when a fault has occurred to the main assignment blade PC and the access from the main assignment blade PC to the storage device is cut off and it is made to be able to be accessed only from the alternative assignment blade PC, if the main assignment blade PC is only turned off power, when it is activated for the maintenance it tries the connection to the storage and there is a possibility that a double access will occur. The process flow which shows that the maintenance can be performed safely without that the connection between the blade PC of main assignment and the storage device is not made in such a case will be shown in FIG. 13.

If the administrator finds a blade PC whose status (145) in the blade assignment management table (14) is failure, he or she starts the process because it is necessary to maintain it (process 1200). The power of the main assignment blade PC (3) whose attribute (145) of the blade assignment management table (14) is failure is turned on (process 1201). With the power being turned on, the OS is activated (process 1202). The blade PC (3) refers to the storage connection information table (33) and tries to connect to the storage device (4) using the IP address (331), the target name (332), the initiator name (333), the CHAP ID (334), and the CHAP Secret (335) (process 1203). However, the CHAP Secret (435) of the storage management table (43) of the storage device (4) has already been changed at the process 1124 and the connection information which said main assignment blade PC possesses has been invalidated, it cannot make the connection (process 1204). Meanwhile the administrator performs the maintenance of the main assignment blade PC (process 1205). The status (145) of the blade assignment management table (14) of the management server (1) is made to be maintenance complete (process 1206).

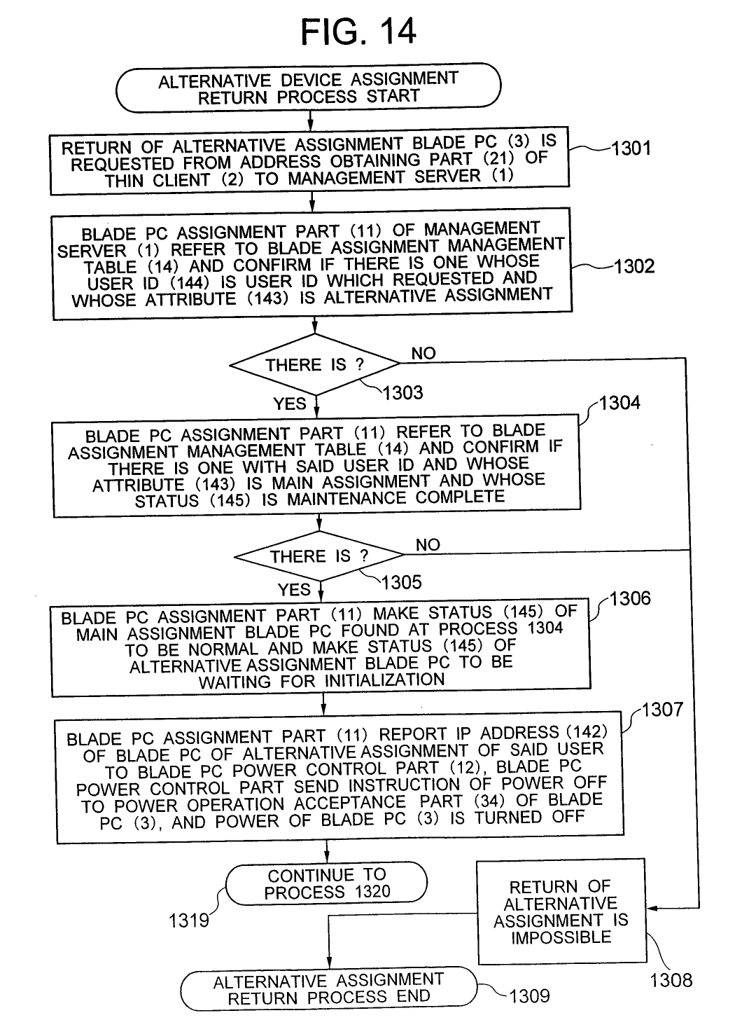

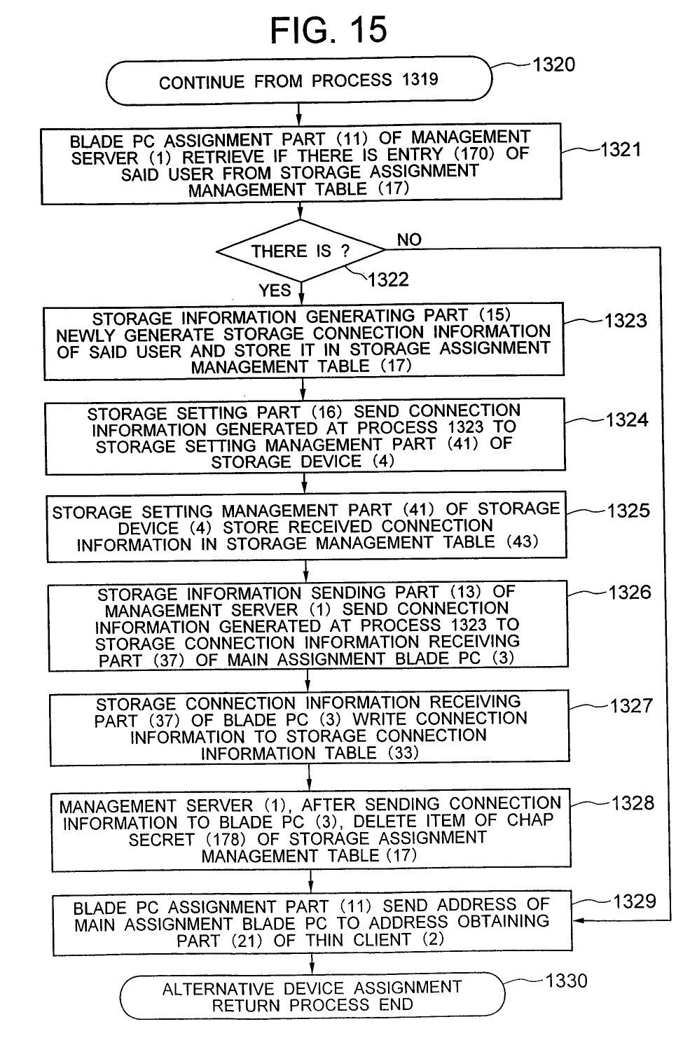

An example of the process flow until the user becomes able to use again the main assignment blade PC which has completed the maintenance will be shown using FIGS. 14 and 15. The user starts the alternative device assignment return process after a certain time has passed or he or she receives notice from the administrator.

First, the return of the alternative assignment blade PC (3) is requested from the address obtaining part (21) of the thin client (2) to the management server (1) (process 1301). The blade PC assignment part (11) of the management server (1) refers to the blade assignment management table (14) and confirms whether there is a user ID (144) in said blade assignment management table corresponding to the user ID which made the request whose attribute (143) is the alternative assignment (process 1302). If there is not a corresponding entry (140), as the alternative assignment cannot be returned (process 1308) this process is terminated (process 1309).

If there is an entry (140) at the branch of process 1303, the blade PC assignment part (11) refers to the blade assignment management table (14) and confirms whether there is an entry whose user ID is said user ID, whose attribute (143) is the main assignment, and whose status (145) is maintenance complete (process 1304). If there is not a corresponding entry, as the alternative assignment cannot be returned (process 1308) this process is terminated with failure (process 1309).

If there is an entry (140) at the branch of process 1305, the blade PC assignment part (11) makes the status (145) of the main assignment blade PC which was found at the process 1304 to be normal and makes the status (145) of the alternative assignment blade PC to be waiting for initialization (process 1306). The blade PC assignment part (11) of the management server reports the IP address (142) of the blade PC of alternative assignment of said user to the blade PC power control part (12), the blade PC power control part sends the instruction of power off to the power operation acceptance part (34) of said alternative assignment blade PC (3), and the power of said alternative assignment blade PC (3) is turned off (process 1307). The blade PC assignment part (11) of the management server (1) retrieves whether there is an entry (170) of said user from the storage assignment management table (process 1321).

If there is not a corresponding entry (170) at the branch of process 1322, the blade PC assignment part (11) sends the address of the main assignment blade PC to the address obtaining part (21) of the thin client (2) (process 1329).

If there is a corresponding entry (170) at the branch of the process 1322, the storage information generating part (15) newly generates the storage connection information of said user and stores it in the storage assignment management table (17) of the management server (process 1323). The storage setting part (16) sends the connection information generated at the process 1323 to the storage setting management part (41) of the storage device (4) (process 1324). The storage setting management part (41) of the storage device (4) stores the received connection information in the storage management table (43) (process 1325). The storage information sending part (13) of the management server (1) sends the connection information generated at the process 1323 to the storage connection information receiving part (37) of the main assignment blade PC (3) (process 1326). The storage connection information receiving part (37) of the blade PC (3) writes the connection information to the storage connection information table (33) (process 1327). The management server (1), after sending the connection information to the blade PC (3), deletes the item of the CHAP Secret (178) of the storage assignment management table (17) (process 1328). The blade PC assignment part (11) sends the address of the main assignment blade PC to the address obtaining part (21) of the thin client (2) (process 1329). With this the alternative device assignment return process is terminated and thereafter the blade PC of main assignment which has been used before becomes able to be used (process 1330).

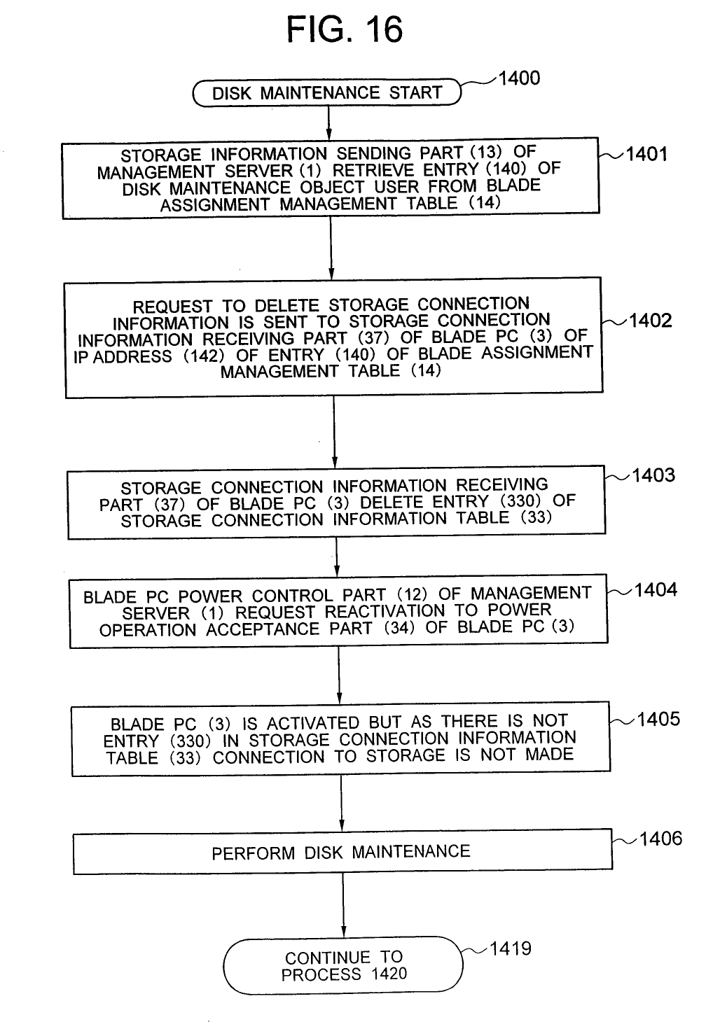

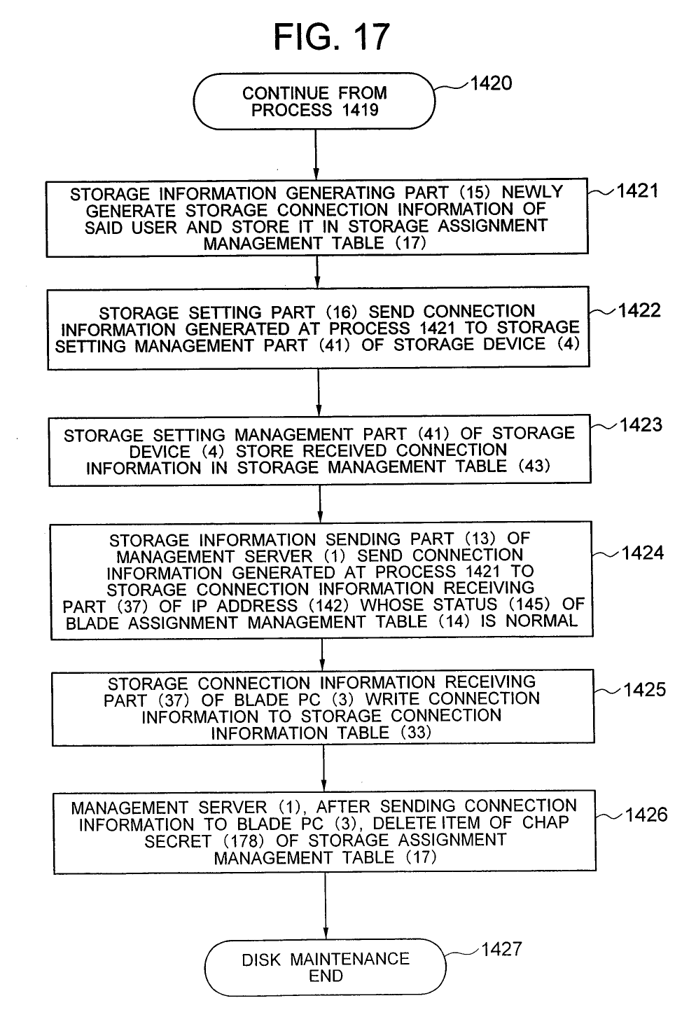

In FIGS. 16 and 17, an example of the process flow when the maintenance of the disk becomes necessary is shown. As an example of the case where this maintenance of the disk has become necessary there is a case where the disk which has been provided for the user has to be maintained because of a claim from the user, virus scan, and check disk, etc., and in this case it is necessary to realize the exclusion between the user and the administrator.

First, the storage information sending part (13) of the management server (1) retrieves an entry (140) of the user which is the object of the disk maintenance from the blade assignment management table (14) (process 1401). A request to delete the storage connection information is sent to the storage connection information receiving part (37) of the blade PC (3) of the IP address (142) of the entry (140) of the blade assignment management table (14) (process 1402). The storage connection information receiving part (37) of the blade PC (3) deletes the entry (330) of the storage connection information table (33) (process 1403). The blade PC power control part (12) f the management server (1) requests the reactivation to the power operation acceptance part (34) of the blade PC (3) (process 1404). In this example of the process flow, the reactivation request of the blade PC (3) is made actively from the management server (1), but it may wait the timing when the usage of the user terminates and the user terminates of his or her own accord. The blade PC (3) is activated but there is not an entry (330) in the storage connection information table (33), therefore the connection to the storage is not made (process 1405). Meanwhile the administrator performs the maintenance of the disk (process 1406). The storage information generating part (15) newly generates the storage connection information of said user and stores it in the storage assignment management table (17) (process 1421). The storage setting part (16) sends the connection information generated at the process 1421 to the storage setting management part (41) of the storage device (4) (process 1422). The storage setting management part (41) of the storage device (4) stores the received connection information in the storage management table (43) (process 1423). The storage connection information sending part (13) of the management server (1) sends the connection information generated at the process 1421 to the storage connection information receiving part (37) of the IP address (142) whose status (145) in the blade assignment management table (14) is normal (process 1424). The storage connection information receiving part (37) of the blade PC (3) writes the connection information to the storage connection information table (33) (process 1425). The management server (1), after sending the connection information to the blade PC (3), deletes the item of the CHAP Secret (178) of the storage assignment management table (17) (process 1426). Thereby, the disk maintenance is terminated and the user becomes able to user it again (process 1427).

According to the embodiment which has been explained above, it has an effect that the destruction of the file system can be prevented because it can prevent the area of the storage device which is assigned to the user from being used at the same time from a plurality of blade PCs.

By providing an appropriate storage device via an appropriate blade PC for the user of the thin client, it can be realized the prevention of the destruction of the contents and the loss of data caused by that the storage device is used from a plurality of blade PCs.

Also, it has an effect that although the operation administrator activates the main assignment blade PC for the maintenance the storage is not to be used by mistake.

Further, it is possible to perform the maintenance such as check disk, backup, and virus scan on the administrator side having made the storage part which is assigned to the user of the storage device unable to be used from the user.

Moreover, a secure system can be configured because it becomes unnecessary to manage permanently the connection password for the storage device by the server.

It should be further understood by those skilled in the art that although the foregoing description has been made on embodiments of the invention, the invention is not limited thereto and various changes and modifications may be made without departing from the spirit of the invention and the scope of the appended claims.

1. An information processing system comprising a network connecting a user terminal, a computer which comprises a plurality of computer units, a storage device, and a management server, wherein:
the management server comprises a computer assignment part which performs assignment of the computer unit, a computer assignment management table which manages assignment condition of the computer unit, a storage connection information generating part which newly generates connection information between the computer unit and the storage device, a storage assignment management table which manages the connection information, and a storage information sending part which sends the connection information to the computer;
the user terminal sends an alternative assignment request to the management server indicating assignment of a second computer unit which is to be an alternative for a first computer unit which is a computer unit which already has been assigned among the plurality of computer units;
the computer assignment part changes value in the computer assignment management table based on the alternative assignment request and changes the computer unit which is assigned to the user terminal from the first computer unit to the second computer unit;
the storage information generating part newly generates second storage connection information connecting between the second computer unit and the storage which is different from first storage connection information connecting between the first computer unit and the storage and stores it in the storage assignment management table; and
the storage information sending part deletes the first storage connection information in the storage assignment management table after sending the second storage connection information to the second computer unit.

2. An information processing system according to claim 1, wherein:
the management server further comprises a storage setting part which sets the connection information to the storage device;
the storage device comprises said storage device and a storage management table;
the storage setting part sends the second storage connection information to the storage device; and
the storage device changes information included in the storage management table based on the second storage connection information.

3. An information processing system according to claim 2, wherein:
the storage assignment management table comprises any one of items of a disk ID which specifies uniquely a storage part in the storage device, a user ID with which said disk ID is assigned to a user, an IP address which indicates connection destination of assigned storage device, a target name, an initiator name, a management port, a CHAP ID, and a CHAP Secret; and
the storage information generating part generates the second storage connection information by changing value of any item of the IP address, the target name, the initiator name, the CHAP ID, and the CHAP Secret.

4. An information processing system according to claim 3, wherein:
the computer assignment part sends an address of the second computer unit to the user terminal.

5. An information processing system according to claim 4, wherein:
the management server further comprises a computer power control part which controls power condition of the computer unit;
the computer assignment part reports an address of the first computer unit to the computer power control part; and
the computer power control part sends a power off instruction of the first computer unit to the computer.

6. An information processing system according to claim 1, wherein:
the computer assignment management table comprises items of a computer identifier, an IP address which is an address of said computer, an attribute indicating a form of assignment, a user identifier indicating to which user it has been assigned, and an assignment status indicating assignment status of said computer, and when computer unit alternation is performed, value of the attribute or the assignment status is changed.

7. An information processing system according to claim 1, wherein:
return of the second computer unit is requested from the user terminal to the management server; and
the management server changes value in the computer assignment management table based on the return request and changes computer unit which is assigned to the user terminal from the second computer unit to the first computer unit.

8. An information processing system according to claim 7, wherein:
the storage information generating part newly generates third storage connection information connecting between the first computer unit and the storage which is different from the second storage connection information connecting between the second computer unit and the storage and stores it in the storage assignment management table; and
the storage information sending part deletes the second storage connection information in the storage assignment management table after sending the third storage connection information to the first computer unit.
